(19) United States
(12) Patent Application Publication
(10) Pub. No.: US 2014/0132956 A1
(43) Pub. Date: May 15, 2014

(54) OBJECT DETECTING DEVICE AND INFORMATION ACQUIRING DEVICE

(71) Applicant: SANYO Electric Co., Ltd., Osaka (JP)

(72) Inventors: Katsumi UMEDA, Aichi (JP); Yoichiro GOTOH, Gifu (JP)

(73) Assignee: SANYO Electric Co., Ltd., Osaka (JP)

(21) Appl. No.: 14/157,241

(22) Filed: Jan. 16, 2014

Related U.S. Application Data
(63) Continuation of application No. PCT/JP2012/068050, filed on Jul. 17, 2012.

(30) Foreign Application Priority Data
Jul. 22, 2011 (JP) 2011161219
Aug. 25, 2011 (JP) 2011184171

(51) Int. Cl. G01J 3/46

(52) U.S. Cl. CPC G01J 3/46
USPC 356/402

(57) ABSTRACT

An information acquiring device includes a projecting portion which projects a laser light emitted from a laser light source onto a target area, and a light receiving portion which receives the laser light reflected on the target area. The light receiving portion includes a color image sensor. The color image sensor has characteristics such that a detection sensitivity of a pixel that detects light of a predetermined color gradually decreases, and detection sensitivities of pixels that detect light of colors other than the predetermined color respectively have local maximum values on a long wavelength side than a visible light region, the detection sensitivities of the respective pixels substantially coinciding with each other in a wavelength band near a wavelength at which the local maximum values are given. An emission wavelength of the laser light source is set to a wavelength in the wavelength band.

This application claims priority under 35 U.S.C. Section 119 of Japanese Patent Application No. 2011-161219 filed Jul. 22, 2011, entitled “INFORMATION ACQUIRING DEVICE AND OBJECT DETECTING DEVICE” and Japanese Patent Application No. 2011-184171 filed Aug. 25, 2011, entitled “INFORMATION ACQUIRING DEVICE AND OBJECT DETECTING DEVICE”. The disclosures of the above applications are incorporated herein by reference.

### BACKGROUND OF THE INVENTION

1. Field of the Invention

The present invention relates to an object detecting device for detecting an object in a target area, based on a state of reflected light when light is projected onto the target area, and an information acquiring device incorporated with the object detecting device.

2. Disclosure of Related Art

Conventionally, there has been developed an object detecting device using light in various fields. An object detecting device incorporated with a so-called distance image sensor is operable to detect not only a two-dimensional image on a two-dimensional plane but also a depthwise shape or a movement of an object to be detected. In such an object detecting device, light in a predetermined wavelength band is projected from a laser light source or an LED (Light Emitting Diode) onto a target area, and light reflected on the target area is received by a light receiving element such as a CMOS image sensor. Various types of sensors are known as the distance image sensor.

In a distance image sensor configured to irradiate laser light having a predetermined dot pattern onto a target area, light of the laser light having the dot pattern reflected on the target area is received by a light receiving element. Then, a distance to each portion of an object to be detected (a distance to the irradiation position of each dot on the object to be detected) is detected, based on the light receiving position of the corresponding dot on the light receiving element, using a triangulation method (see e.g. pp. 1279-1280, the 19th Annual Conference Proceedings (Sep. 18-20, 2001) by the Robotics Society of Japan).

In the object detecting device as described above, infrared light having a dot pattern is irradiated onto a target area, and infrared light reflected on an object within the target area is received by a monochromatic image sensor. However, the amount of production of monochromatic image sensors is small, and the monochromatic image sensors are expensive. Accordingly, there is a problem that the cost of the entirety of the device may increase.

### SUMMARY OF THE INVENTION

A first aspect according to the invention is directed to an information acquiring device. The information acquiring device according to the first aspect includes a laser light source which emits laser light, a projecting portion which projects the laser light emitted from the laser light source onto a target area, and a light receiving portion which receives the laser light reflected on the target area. In this configuration, the light receiving portion includes a color image sensor into which the laser light reflected on the target area enters. Further, the color image sensor has characteristics such that a detection sensitivity of a pixel that detects light of a predetermined color gradually decreases, and detection sensitivities of pixels that detect light of colors other than the predetermined color respectively have local maximum values on a long wavelength side than a visible light region, the detection sensitivities of the respective pixels substantially coinciding with each other in a wavelength band near a wavelength at which the local maximum values are given. An emission wavelength of the laser light source is set to a wavelength in the wavelength band.

A second aspect according to the invention is directed to an object detecting device. The object detecting device according to the second aspect includes the information acquiring device according to the first aspect.

### BRIEF DESCRIPTION OF THE DRAWINGS

These and other objects, and novel features of the present invention will become more apparent upon reading the following detailed description of the embodiment along with the accompanying drawings.

FIG. 1 is a diagram showing a schematic configuration of an object detecting device embodying the invention;

FIG. 2 is a diagram showing configurations of an information acquiring device and an information processing device in the embodiment;

FIGS. 3A and 3B are diagrams respectively and schematically showing an irradiation state of laser light onto a target area, and a light receiving state of laser light on a CMOS image sensor in the embodiment;

FIGS. 4A and 4B are diagrams describing a distance detecting method in the embodiment;

FIGS. 5A to 5C are diagrams describing a method for detecting a displacement position of a segment area on a reference template at the time of actual measurement in the embodiment;

FIGS. 6A to 6E are schematic diagrams showing configurations of a monochromatic sensor and a color sensor in the embodiment;

FIG. 7 is a diagram showing spectral characteristics of the color sensor in the embodiment;

FIGS. 8A to 8D are diagrams showing laser light having a dot pattern, in the case where a color sensor is used as a CMOS image sensor in the embodiment; and

FIGS. 9A to 9C are diagrams showing spectral characteristics of other color sensors.

The drawings are provided mainly for describing the present invention, and do not limit the scope of the present invention.

### DESCRIPTION OF PREFERRED EMBODIMENTS

In the following, an embodiment of the invention is described referring to the drawings. In the embodiment, there is described an example of an information acquiring device configured to irradiate laser light having a predetermined dot pattern onto a target area. In the embodiment, an information processing device 2 corresponds to an “object detecting device” in the claims. A projection optical system 100 corresponds to a “projecting portion” in the claims. A DOE 140 corresponds to a “diffractive optical element” in the claims. A light receiving optical system 200 corresponds to a “light receiving portion” in the claims. A CMOS image sensor 240 corresponds to a “color image sensor” in the claims. The description regarding the correspondence between the claims and the embodiment is merely an example, and the claims are not limited by the description of the embodiment.

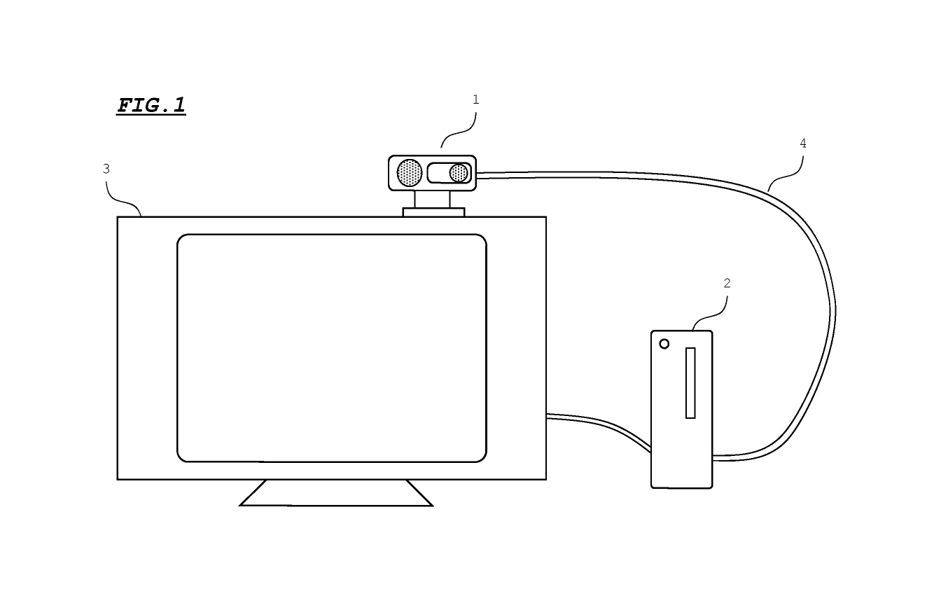

Firstly, a schematic arrangement of an object detecting device according to the first embodiment is described. As shown in FIG. 1, the object detecting device is provided with an information acquiring device 1, and an information processing device 2. ATV 3 is controlled by a signal from the information processing device 2.

The information acquiring device 1 projects infrared light to the entirety of a target area, and receives reflected light from the target area by a CMOS image sensor to thereby acquire a distance (hereinafter, called as “three-dimensional distance information”) to each part of an object in the target area. The acquired three-dimensional distance information is transmitted to the information processing device 2 through a cable 4.

The information processing device 2 is e.g. a controller for controlling a TV or a game machine, or a personal computer. The information processing device 2 detects an object in a target area based on three-dimensional distance information received from the information acquiring device 1, and controls the TV 3 based on a detection result.

For instance, the information processing device 2 detects a person based on received three-dimensional distance information, and detects a motion of the person based on a change in the three-dimensional distance information. For instance, in the case where the information processing device 2 is a controller for controlling a TV, the information processing device 2 is installed with an application program operable to detect a gesture of a user based on received three-dimensional distance information, and output a control signal to the TV 3 in accordance with the detected gesture. In this case, the user is allowed to control the TV 3 to execute a predetermined function such as switching the channel or turning up/down the volume by performing a certain gesture while watching the TV 3.

Further, for instance, in the case where the information processing device 2 is a game machine, the information processing device 2 is installed with an application program operable to detect a motion of a user based on received three-dimensional distance information, and operate a character on a TV screen in accordance with the detected motion to change the match status of a game. In this case, the user is allowed to play the game as if the user himself or herself is the character on the TV screen by performing a certain action while watching the TV 3.

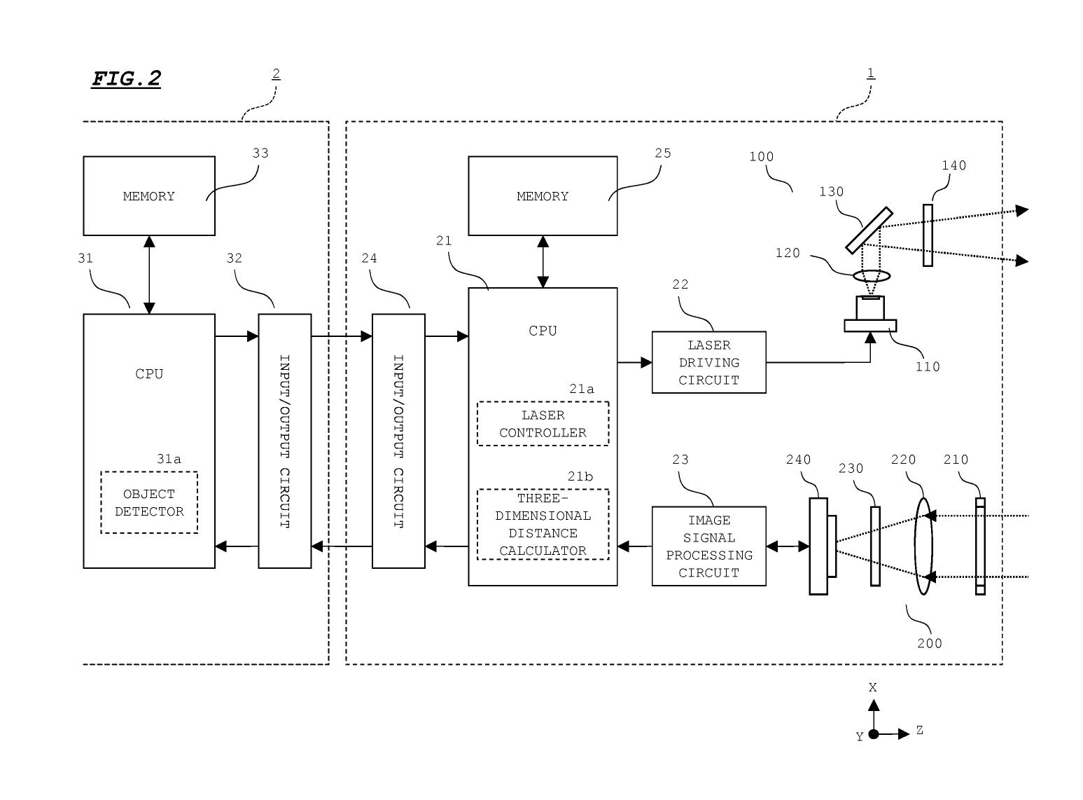

FIG. 2 is a diagram showing an arrangement of the information acquiring device 1 and the information processing device 2.

The information acquiring device 1 is provided with a projection optical system 100 and a light receiving optical system 200, which constitute an optical portion. The projection optical system 100 and the light receiving optical system 200 are disposed side by side away from each other in X-axis direction by a predetermined distance in the information acquiring device 1.

The projection optical system 100 is provided with a laser light source 110, a collimator lens 120, a rise-up mirror 130, and a diffractive optical element (DOE) 140. Further, the light receiving optical system 200 is provided with an aperture 210, an imaging lens 220, a filter 230, and a CMOS image sensor 240. In addition to the above, the information acquiring device 1 is provided with a CPU (Central Processing Unit) 21, a laser driving circuit 22, an image signal processing circuit 23, an input/output circuit 24, and a memory 25, which constitute a circuit portion.

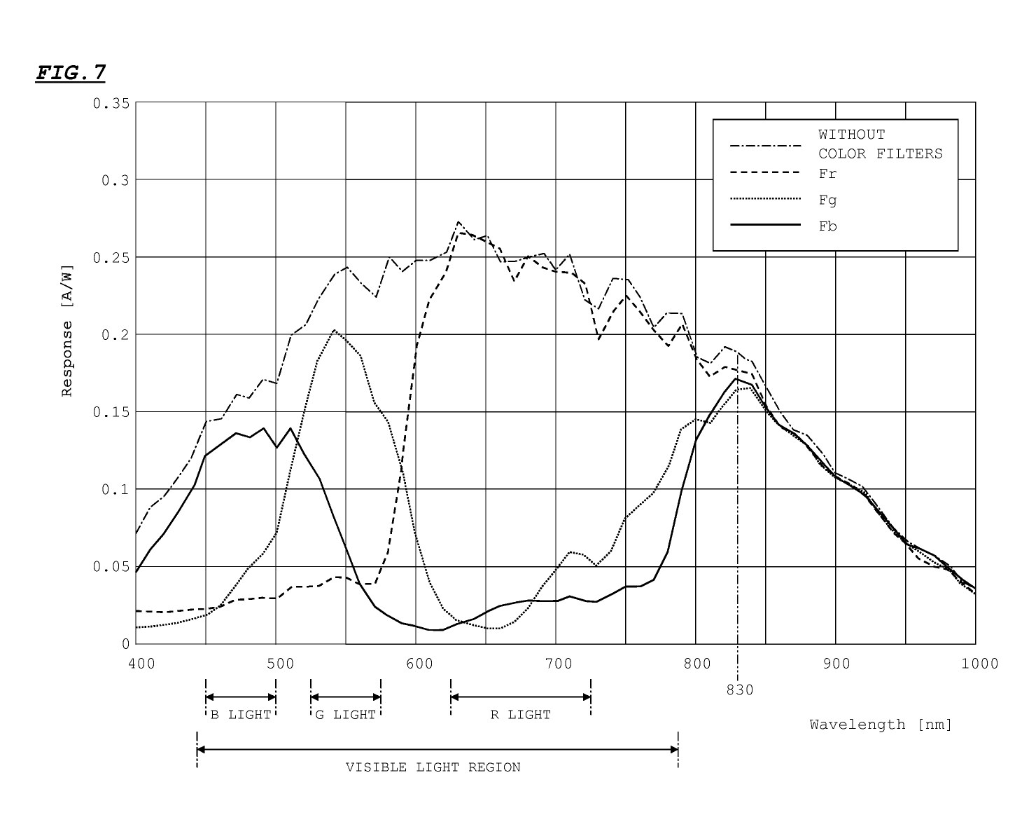

The laser light source 110 outputs laser light in an infrared wavelength band in a direction (plus X-axis direction) away from the light receiving optical system 200. The method for setting the emission wavelength of the laser light source 110 will be described later referring to FIG. 7.

The collimator lens 120 converts laser light emitted from the laser light source 110 into substantially parallel light. The rise-up mirror 130 reflects laser light entered from the collimator lens 120 side in a direction (Z-axis direction) toward the DOE 140.

The DOE 140 has a diffraction pattern on an incident surface thereof. Laser light entered to the DOE 140 is converted into laser light having a dot pattern by a diffraction effect of the diffraction pattern, and is irradiated onto a target area. The diffraction pattern has a structure such that a step-type diffraction hologram is formed with a predetermined pattern. The pattern and the pitch of the diffraction hologram are adjusted in such a manner that laser light entered from the rise-up mirror 130 side is converted into laser light having a dot pattern.

Further, the DOE 140 irradiates laser light entered from the rise-up mirror 130 onto the target area, as laser light having a dot pattern expanding in a radial manner. The size of each dot of the dot pattern corresponds to the beam size of laser light to be incident to the DOE 140. Laser light (zero-th order light) that is not diffracted on the DOE 140 propagates while transmitting through the DOE 140.

Laser light reflected on the target area is entered to the imaging lens 220 through the aperture 210.

The aperture 210 limits external light in accordance with the F-number of the imaging lens 220. The imaging lens 220 collects light entered through the aperture 210 on the CMOS image sensor 240. The filter 230 is an infrared filter (IR filter) which transmits only the light in the infrared wavelength band including the emission wavelength of the laser light source 110. The filter 230 cuts visible light from the light entered to the light receiving optical system 200. In the embodiment, the filter 230 is disposed posterior to the imaging lens 220. Alternatively, the filter 230 may be disposed anterior to the imaging lens 220. Further, the filter 230 may be a narrow band-pass filter which transmits only the light in a narrow wavelength band including the emission wavelength band of the laser light source 110.

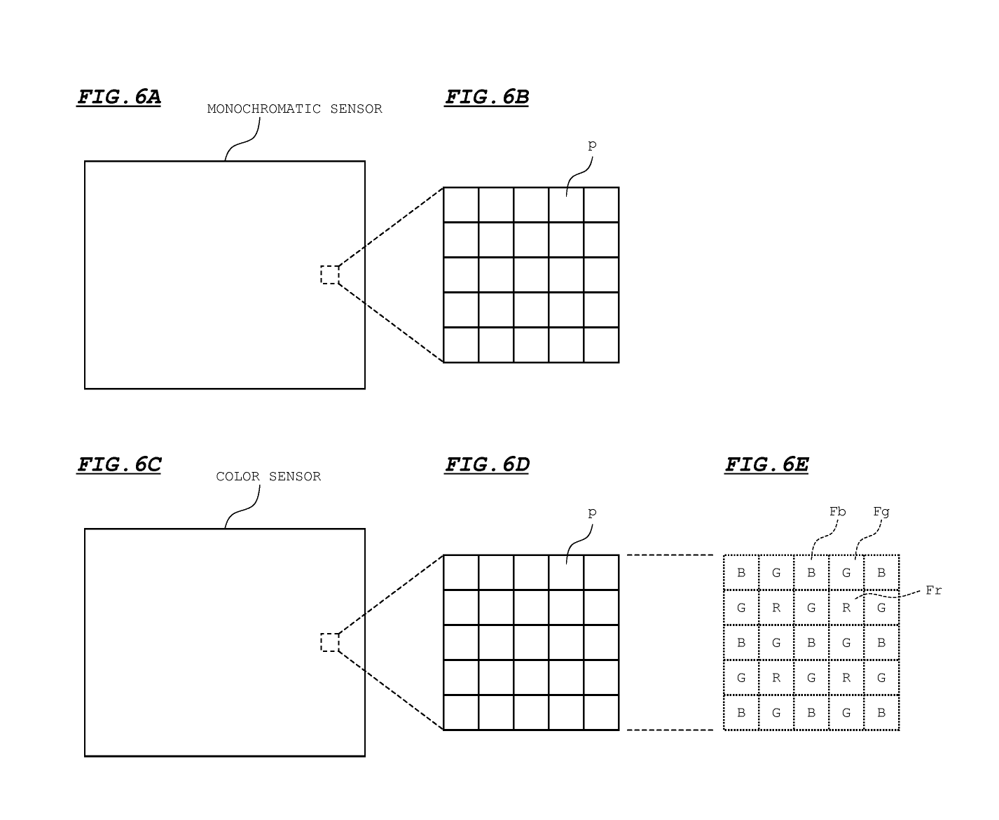

The CMOS image sensor 240 receives light collected by the imaging lens 220, and outputs a signal (electric charge) according to a received light amount to the image signal processing circuit 23, pixel by pixel. In this example, the CMOS image sensor 240 is configured in such a manner that the output speed of signals to be outputted from the CMOS image sensor 240 is set high so that a signal (electric charge) from each pixel can be outputted to the image signal processing circuit 23 with high response upon receiving light at each pixel. The CMOS image sensor 240 will be described later referring to FIGS. 6C to 6E and FIG. 7.

The CPU 21 controls the parts of the information acquiring device 1 in accordance with a control program stored in the memory 25. By the control program, the CPU 21 has a function of a laser controller 21a for controlling the laser light source 110, and a distance calculator 21b for generating three-dimensional distance information.

The laser driving circuit 22 drives the laser light source 110 (to be described later) in accordance with a control signal from the CPU 21.

The image signal processing circuit 23 controls the CMOS image sensor 240 to successively read signals (electric charges) from the pixels, which have been generated in the CMOS image sensor 240, line by line. Then, the image signal processing circuit 23 outputs the read signals successively to the CPU 21. The CPU 21 calculates a distance from the information acquiring device 1 to each portion of an object to be detected, by a processing to be implemented by the distance calculator 21b, based on the signals (image signals) to be supplied from the image signal processing circuit 23. The input/output circuit 24 controls data communications with the information processing device 2.

The information processing device 2 is provided with a CPU 31, an input/output circuit 32, and a memory 33. The information processing device 2 is provided with e.g. an arrangement for communicating with the TV 3, or a drive device for reading information stored in an external memory such as a CD-ROM and installing the information in the memory 33, in addition to the arrangement shown in FIG. 2. The arrangements of the peripheral circuits are not shown in FIG. 2 to simplify the description.

The CPU 31 controls each of the parts of the information processing device 2 in accordance with a control program (application program) stored in the memory 33. By the control program, the CPU 31 has a function of an object detector 31a for detecting an object in an image. The control program is e.g. read from a CD-ROM by an unillustrated drive device, and is installed in the memory 33.

For instance, in the case where the control program is a game program, the object detector 31a detects a person and a motion thereof in an image based on three-dimensional distance information supplied from the information acquiring device 1. Then, the information processing device 2 causes the control program to execute a processing for operating a character on a TV screen in accordance with the detected motion.

Further, in the case where the control program is a program for controlling a function of the TV 3, the object detector 31a detects a person and a motion (gesture) thereof in the image based on three-dimensional distance information supplied from the information acquiring device 1. Then, the information processing device 2 causes the control program to execute a processing for controlling a predetermined function (such as switching the channel or adjusting the volume) of the TV 3 in accordance with the detected motion (gesture).

The input/output circuit 32 controls data communication with the information acquiring device 1.

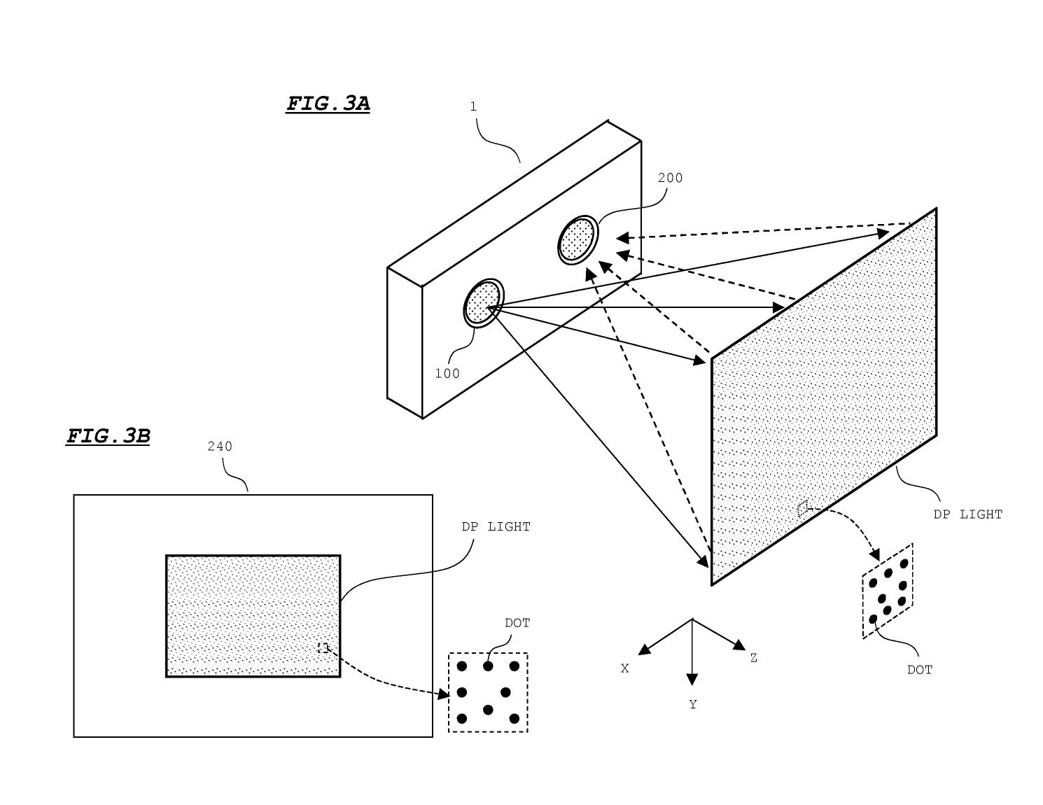

FIG. 3A is a diagram schematically showing an irradiation state of laser light onto a target area. FIG. 3B is a diagram schematically showing a light receiving state of laser light on the CMOS image sensor 240. To simplify the description, FIG. 3B shows a light receiving state in the case where a flat plane (screen) is disposed on a target area.

As shown in FIG. 3A, laser light having a dot pattern (hereinafter, the entirety of the laser light having the dot pattern is called as “DP light”) is irradiated onto the target area from the projection optical system 100. In a light flux of DP light, dot areas (hereinafter, simply called as “dots”) to which the laser light is divided by the diffraction effect of the DOE 140 are distributed according to the dot pattern resulting from the diffraction effect of the DOE 140. Providing a flat plane (screen) on the target area makes it possible to distribute DP light reflected on the screen onto the CMOS image sensor 240, as shown in FIG. 3B.

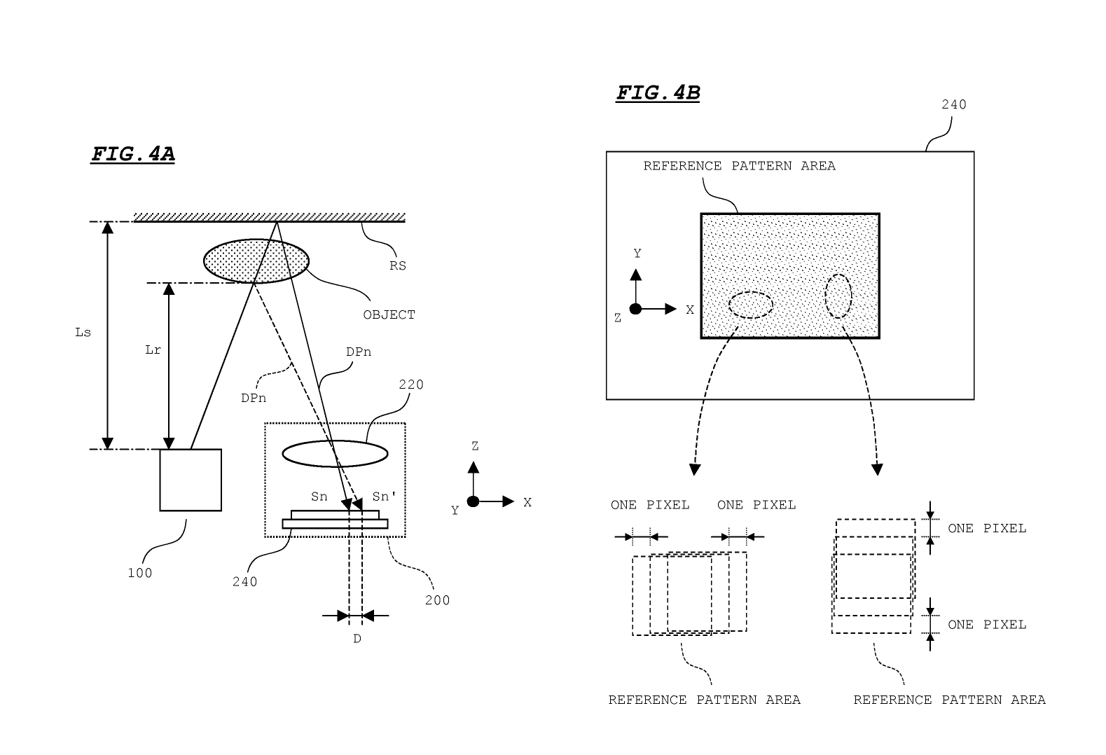

In the following, the aforementioned distance detecting method is described referring to FIGS. 4A and 4B.

Firstly, as shown in FIG. 4A, a flat reflection plane RS which extends perpendicular to Z-axis direction is disposed at a position away from the projection optical system 100 by a predetermined distance Ls. DP light outputted from the projection optical system 100 is reflected on the reflection plane RS, and is entered to the CMOS image sensor 240 in the light receiving optical system 200. Then, an electrical signal from each pixel is outputted from the CMOS image sensor 240. The value (pixel value) of the electrical signal outputted from each pixel is expanded in the memory 25 shown in FIG. 2. Then, as shown in FIG. 4B, a “reference pattern area” which defines an irradiation area of DP light on the CMOS image sensor 240 is set.

With respect to the reference pattern area set in this manner, a plurality of segment areas each having a predetermined size (e.g. 15 pixels in vertical direction and 15 pixels in horizontal direction) are set. The segment areas are set to align with each other at an interval of one pixel with respect to the reference pattern area. Specifically, a certain segment area is disposed at a position respectively away from four segment areas adjacent to the segment area vertically and horizontally by the distance corresponding to one pixel. In the above configuration, dots are distributed with a unique pattern on each of the segment areas. Accordingly, the pattern of pixel values within a segment area differs with respect to each of the segment areas.

In this way, information relating to the position of the reference pattern area on the CMOS image sensor 240, the pixel values (a reference pattern) of all the pixels included in the reference pattern area and information relating to the segment areas relative to the reference pattern area are stored in the memory 25 shown in FIG. 2. These information stored in the memory 25 is hereinafter called as a “reference template”.

The CPU 21 shown in FIG. 2 refers to the reference template in calculating a distance from the projection optical system 100 to each portion of an object to be detected. In calculating the distance, the CPU 21 calculates the distance to each portion of the object, based on a displacement amount of a dot pattern in each of the segment areas, which is obtained from the reference template.

For instance, in the case where an object is located at a position away the projection optical system 100 by a distance shorter than the distance Ls shown in FIG. 4A, DP light (DPn) corresponding to a predetermined segment area Sn on the reference pattern is reflected on the object, and is entered to an area Sn′ different from the segment area Sn. Since the projection optical system 100 and the light receiving optical system 200 are adjacent to each other in X-axis direction, the displacement direction of the area Sn′ relative to the segment area Sn is aligned in parallel to X-axis. In the case shown in FIG. 4A, since the object is located at a position away from the projection optical system 100 by a distance shorter than the distance Ls, the area Sn′ is displaced relative to the segment area Sn in plus X-axis direction. In the case where the object is located at a position away from the projection optical system 100 by a distance longer than the distance Ls, the area Sn′ is displaced relative to the segment area Sn in minus X-axis direction.

A distance Lr from the projection optical system 100 to a portion of the object irradiated with DP light (DPn) is calculated, with use of the distance Ls, based on the displacement direction and the displacement amount of the area Sn′ relative to the segment area Sn according to a triangulation method. A distance from the projection optical system 100 to each other portion of the object corresponding to each other segment area is calculated in the same manner as described above. The details on the calculation method are described in pp. 1279-1280, the 19th Annual Conference Proceedings (Sep. 18-20, 2001) by the Robotics Society of Japan).

In the distance calculation as described above, it is necessary to detect a displacement position of the segment area Sn on the reference template at the time of actual measurement. The detection is performed by performing a matching operation between a dot pattern of DP light irradiated onto the CMOS image sensor 240 at the time of actual measurement, and a dot pattern included in the segment area Sn.

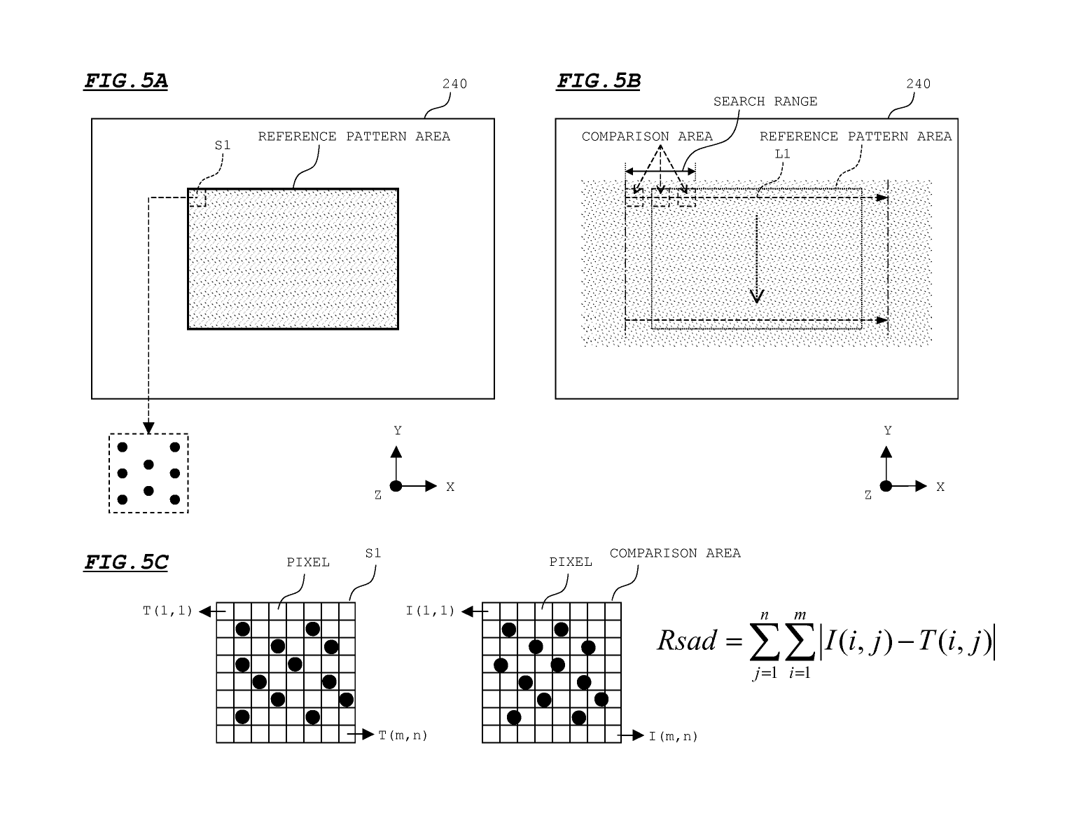

FIGS. 5A to 5C are diagrams describing the detecting method. FIG. 5A is a diagram showing a reference pattern area on the CMOS image sensor 240, FIG. 5B is a diagram showing a light receiving state on the CMOS image sensor 240 at the time of actual measurement, and FIG. 5C is a diagram describing a matching method between a dot pattern of actually measured DP light, and a dot pattern included in a segment area on the reference template.

In the case where a displacement position of a segment area S1 shown in FIG. 5A at the time of actual measurement is searched, as shown in FIG. 5B, an area defined by the segment area S1 is fed pixel by pixel within a predetermined range (search range) in X-axis direction. In each of the feeding areas (comparison areas), a degree of matching between the dot pattern of the segment area S1 stored in the reference template, and the dot pattern of actually measured DP light is obtained. The above operation is performed based on the idea that normally a dot pattern of a segment area set by the reference template is displaced only within a predetermined range in X-axis direction at the time of actual measurement, as described above.

At the time of detecting the degree of matching, a degree of similarly between a comparison area and the segment area S1 is obtained. Specifically, a difference between the pixel value of each of the pixels in the segment area S1, and the pixel value of a corresponding pixel in a comparison area is obtained. Then, a value Rsad obtained by summing up the differences with respect to all the pixels within the comparison area is acquired as a value representing the degree of similarity.

For instance, as shown in FIG. 5C, in the case where pixels of m columns by n rows are included in one segment area, a difference between a pixel value T (i,j) of a pixel at the i-th column and the j-th row in the segment area, and a pixel value I (i,j) of a pixel at the i-th column and the j-th row in the comparison area is obtained. The difference is obtained with respect to all the pixels in the segment area, and the value Rsad is obtained according to the formula shown in FIG. 5C by summing up the differences. As the value Rsad decreases, the degree of similarity between a segment area and a comparison area increases.

After the value Rsad is obtained for the segment area S1 with respect to all the comparison areas in the search range, a value smaller than a threshold value is extracted from the obtained values Rsad. In the case where there is no value Rsad smaller than the threshold value, it is determined that the searching operation of the segment area S1 has failed. Then, a comparison area having a smallest value of the extracted values Rsad is determined to be an area corresponding to the segment area S1 after the displacement.

Likewise, a searching operation is performed for the segment area adjacent to the right of the segment area S1. In this way, a searching operation is performed sequentially along a line L1 for the segment areas in the uppermost row within the reference pattern area. Further, a searching operation is performed for the segment areas on the other lines substantially in the same manner as described above.

After a displacement position of each of the segment areas has been searched from the dot pattern of DP light acquired at the time of actual measurement as described above, a distance to each portion of the object to be detected, which corresponds to each segment area, is obtained by a triangulation method based on the displacement positions.

In the following, there is described a case of using a monochromatic image sensor (hereinafter, called as a “monochromatic sensor”) as the CMOS image sensor 240 in an example of the embodiment.

FIGS. 6A and 6B are schematic diagrams showing a configuration of a monochromatic sensor. FIG. 6A is a diagram showing the entirety of a light receiving surface of the monochromatic sensor, and FIG. 6B is a partially enlarged view of the monochromatic sensor.

As shown in FIG. 6B, a plurality of pixels “p” are disposed on the light receiving surface of the monochromatic sensor. Each pixel “p” is provided with a photodetector, and outputs a signal (electric charge) according to a received light amount.

As described above, out of the light entered to the light receiving optical system 200, visible light is cut by the filter 230 (see FIG. 2) . Further, since laser light having a dot pattern reflected on the target area is infrared light, the laser light is transmitted through the filter 230. Accordingly, using a monochromatic sensor as the CMOS image sensor 240 makes it possible to properly output, as a signal from each pixel, a signal according to the light amount of each dot of laser light having a dot pattern reflected on the target area.

However, the production amount of monochromatic sensors is small, and the monochromatic sensors are expensive. Accordingly, there is a problem that the cost of the entirety of the device may increase. In view of the above, the inventor of the present application proposes an idea of using, as the CMOS image sensor 240, a color image sensor (hereinafter, called as “color sensor”) in place of using an expensive monochromatic sensor, in view of a point that the production amount of color image sensors is large and the color image sensors are inexpensive. Examples of a color sensor usable as the CMOS image sensor 240 are a color sensor loaded in a camera unit of an existing mobile phone, and a color sensor loaded in a camera unit of a video camera or a digital camera.

FIGS. 6C to 6E are schematic diagrams showing a configuration of a color sensor. FIG. 6C is a diagram showing the entirety of a light receiving surface of the color sensor, and FIGS. 6D and 6E are partially enlarged views of the color sensor.

As shown in FIG. 6D, a plurality of pixels “p” are disposed on the light receiving surface of the color sensor, as with the case of the monochromatic sensor. Further, as shown in FIG. 6E, color filters Fr which transmit light (hereinafter, called as “R light”) in a red wavelength band, color filters Fg which transmit light (hereinafter, called as “G light”) in a green wavelength band, and color filters Fb which transmit light (hereinafter, called as “B light”) in a blue wavelength band are disposed on the light incident side of the pixels “p” in an orderly manner. Either one of the color filters Fr, Fg, and Fb is disposed on each pixel “p”.

FIG. 7 is a diagram showing spectral characteristics of the color sensor having the above configuration. Referring to FIG. 7, the horizontal axis shows a wavelength of light to be incident to a color filter, and the vertical axis shows a sensitivity of a pixel “p” corresponding to the color filter. In this example, the sensitivity is represented by a ratio between a current (A) to be outputted from a pixel “p”, and a light amount (W) of light to be incident to a color filter. In FIG. 7, the one-dotted chain line indicates a sensitivity in the case where a color filter is not disposed, and corresponds to a sensitivity in the case where a monochromatic sensor is used.

FIG. 7 shows spectral characteristics, in the case where one of the general-purpose CMOS color sensors to be used in a camera unit of an existing mobile phone is evaluated as a sample sensor.

As shown in FIG. 7, the color filter Fr is configured to easily transmit light (R light) in a wavelength range of from about 650 to 750 nm. The color filter Fg is configured to easily transmit light (G light) in a wavelength range of from about 525 to 575 nm. The color filter Fb is configured to easily transmit light (B light) in a wavelength range of from about 450 to 500 nm.

When visible light is entered to the color sensor, R light, G light, and B light included in visible light are respectively and exclusively transmitted through the color filters Fr, Fg, and Fb. By performing the above operation, the shape and the color of an object to be detected are determined, based on signals (electric charges) to be outputted from the pixels “p” which detect R light, G light, and B light (pixels “p” corresponding to the color filters Fr, Fg, and Fb).

However, it is impossible to properly output signals according to laser light having a dot pattern from a color sensor, as will be described in the following, simply by using a color sensor having the aforementioned spectral characteristics as the CMOS image sensor 240, in place of a monochromatic sensor.

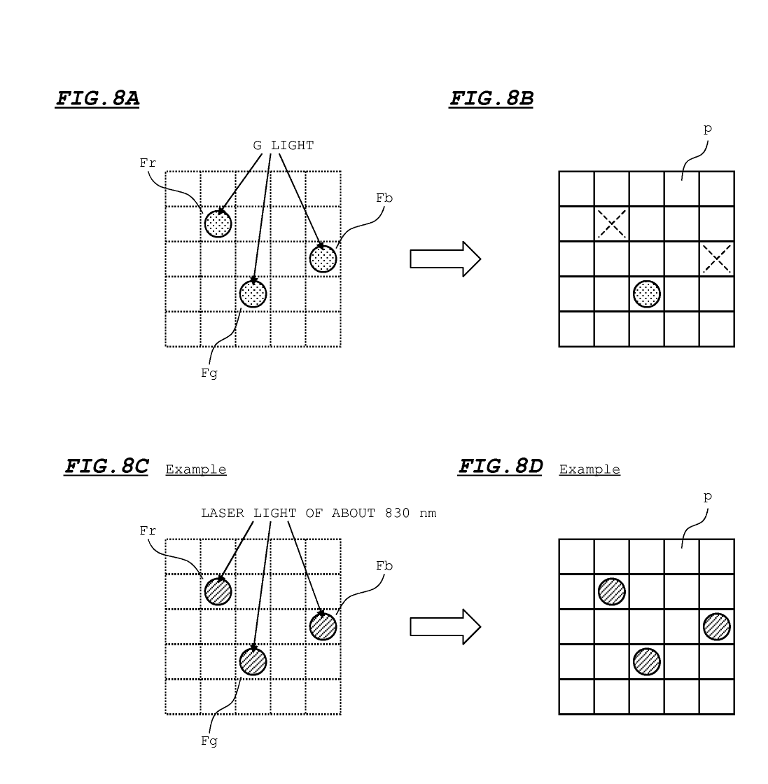

FIGS. 8A and 8B are diagrams showing laser light having a dot pattern, in the case where a color sensor is used as the CMOS image sensor 240. FIG. 8A is a diagram showing dots to be irradiated onto the color filters Fr, Fg, and Fb shown in FIG. 6E, and FIG. 8B is a diagram showing a dot to be irradiated onto a pixel “p”.

For instance, let us assume that the emission wavelength band of the laser light source 110 shown in FIG. 2 is near the green wavelength band, and the filter 230 is configured to transmit light in the green wavelength band. FIGS. 8A and 8B show an example of an irradiation state of dots, in the case where the laser light source 110 (see FIG. 2) emits G light.

In the above case, for instance, as shown in FIG. 8A, in the case where three dots of G light are irradiated onto the color sensor, the color sensor is incapable of detecting the dots to be irradiated onto the color filters Fr and Fb other than the color filter Fg. Specifically, even if three dots are irradiated as shown in FIG. 8A, two dots out of the three dots do not impinge on the pixels “p” as indicated by x marks in FIG. 8B, because G light does not substantially transmit through the color filters Fr and Fb. Likewise, in the case where the laser light source 110 emits R light or B light, the color sensor is incapable of detecting a dot irradiated onto the color filter which does not substantially transmit R light or B light, because the dot does not impinge on the corresponding pixel “p”.

In this example, there is described a case, in which the laser light source 110 emits G light, R light, or B light. In the case where the emission wavelength of the laser light source 110 is in a wavelength band between G light and R light, or in a wavelength band between Blight and G light, the color sensor is also incapable of properly detecting a dot. For instance, in the case where the emission wavelength of the laser light source 110 is about 600 nm, which is in a wavelength band between G light and R light, as shown in FIG. 7, the sensitivity of a pixel “p” which detects G light decreases, and the sensitivity of a pixel “p” which detects B light further decreases. As a result, if dots are irradiated at the positions where the color filters Fg and Fb are disposed, the dots may not be properly detected. Likewise, in the case where the emission wavelength of the laser light source 110 is about 770 nm, which is near the wavelength of visible light, regardless that the emission wavelength is in the infrared wavelength band, in the case where dots are irradiated at the positions where the color filters Fg and Fb are disposed, the dots may not be properly detected because the sensitivities of the pixels “p” which detect G light and B light are considerably small.

As described above, in the case where a color sensor is used as the CMOS image sensor 240, dot detection failure may occur depending on the emission wavelength of the laser light source 110. This may make it impossible to properly detect laser light having a dot pattern.

In view of the above, the inventor of the present application proposes the idea of setting the emission wavelength of the laser light source 110, as described below, for properly detecting laser light having a dot pattern with use of a color sensor.

Referring to FIG. 7, as described above, the color filters Fr, Fg, and Fb are configured to easily and respectively transmit R light, G light, and B light. Normally, a color sensor is loaded in a camera unit which captures an image of a person or a landscape. Accordingly, the characteristics of the color filters Fr, Fg, and Fb of a color sensor are set based on visible light which is visually recognized by the human eyes. In an existing camera unit, infrared light that cannot be visually recognized by the human eyes is cut off by an infrared cutoff filter or a like member. Accordingly, the characteristics of the color filters Fr, Fg, and Fb in the infrared wavelength band have not been an important factor in a color sensor.

The inventor of the present application has investigated and evaluated the sensitivity of the infrared wavelength band of a color sensor for use in the aforementioned purpose. The inventor found that each of the color filters of a general-purpose color sensor as a sample sensor transmits light of a wavelength near 830 nm substantially equally, as shown in FIG. 7. When light of a wavelength near 830 nm is irradiated onto a color sensor having the spectral characteristics as shown in FIG. 7, the light transmits through each of the color filters substantially equally. Accordingly, using the color sensor as the CMOS image sensor 240, and setting the emission wavelength of the laser light source 110 to about 830 nm makes it possible to suppress dot detection failure as described above, and makes it possible to properly detect laser light having a dot pattern.

As a result of evaluating other existing color sensors, the inventor found that most of the general-purpose color sensors have the aforementioned spectral characteristics in common. Specifically, a general-purpose color sensor has characteristics such that the detection sensitivity of a pixel which detects R light gradually decreases, and the detection sensitivities of pixels which detect G light and B light other than R light respectively have local maximum values on a long wavelength side than the visible light region; and the detection sensitivities of the respective pixels substantially coincide with each other in a wavelength band near the wavelength at which the local maximum values are given. Further, the wavelength at which the detection sensitivities of the pixels which detect G light and B light have the local maximum values is near 830 nm on the long wavelength side than the visible light region.

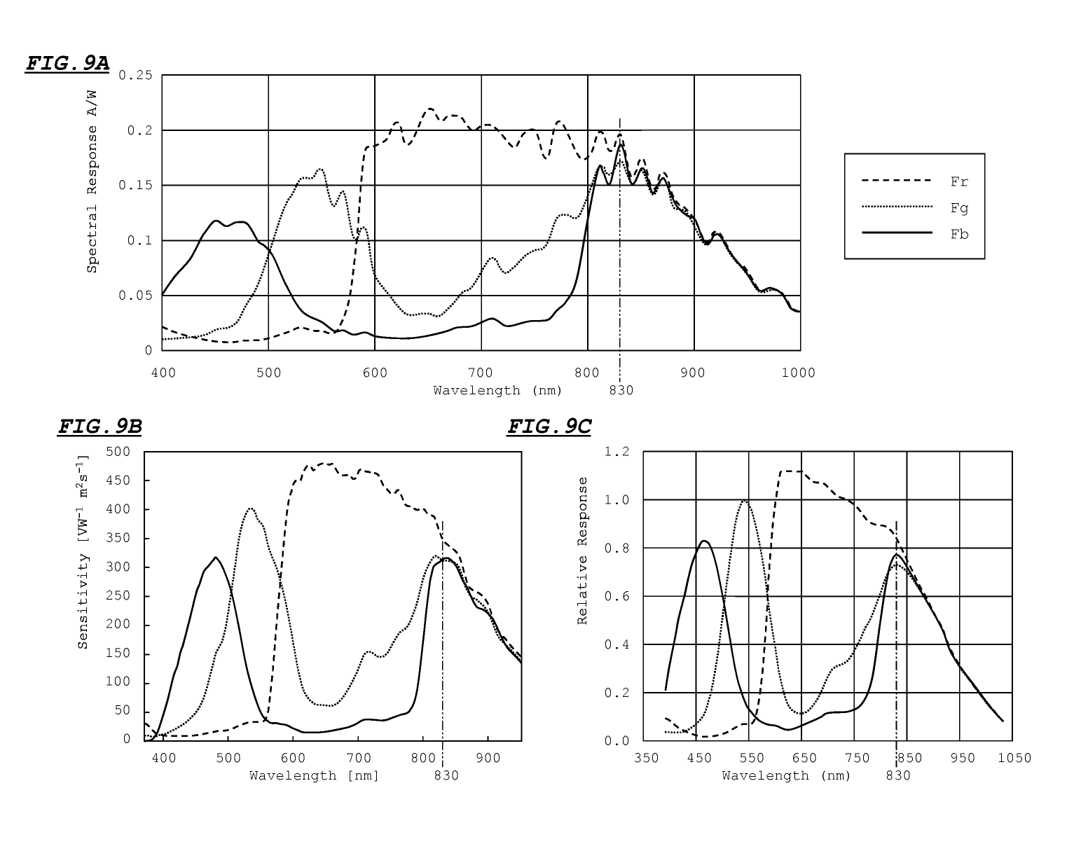

FIGS. 9A to 9C are diagrams showing spectral characteristics of color sensors (manufactured by manufacturers different from each other) different from the spectral characteristics shown in FIG. 7. The vertical axis in FIG. 9B shows a sensitivity represented by a ratio between a voltage (V) to be outputted from a pixel “p”, and a light amount (W) of light to be incident to a color filter. The vertical axis in FIG. 9C shows a relative value of a sensitivity of each of the color filters. In any one of the color sensors shown in FIGS. 9A to 9C, the sensitivities are substantially equal to each other in a wavelength region near 830 nm. The spectral characteristics shown in FIG. 9B are such that the wavelengths at which the detection sensitivities of pixels which detect G light and B light have local maximum values are displaced from each other by about 10 nm. On the other hand, in the spectral characteristics shown in FIGS. 9A and 9C, the wavelengths at which the detection sensitivities of pixels which detect G light and B light have local maximum values substantially coincide with each other.

Thus, the inventor of the present application proposes the idea of setting the wavelength of laser light to be emitted from the laser light source 110 to about 830 nm, in the case where a color sensor is used as the CMOS image sensor 240, taking into consideration of the spectral characteristics of the color sensors as described above.

Specifically, the emission wavelength of the laser light source 110 is set to be a target value in a “reference temperature”, which is a temperature obtained by adding a temperature which may be increased during use of the device, to the temperature which serves as a middle of an ambient temperature range in which the device is used. For instance, assuming that the ambient temperature range in which the device is used is from 0 to 50° C., and a temperature which may be increased during use of the device is about 10° C., the reference temperature is (50/2)+10=35° C. In this case, the emission wavelength of laser light is set to be equal to 830 nm at the reference temperature of 35° C. In the case where emission wavelength variation becomes a problem resulting from ambient temperature variation, a temperature adjusting element may be disposed near the laser light source 110 in order to keep the temperature of the laser light source 110 to the reference temperature. In this example, the reference temperature is set as described above. However, the reference temperature may be set by another method. For instance, the reference temperature may be set to a temperature serving as the middle of an ambient temperature range in which the device is used, or may be set to any temperature within an ambient temperature range in which the device is used.

FIGS. 8C and 8D are diagrams showing a dot pattern on the color filters Fr, Fg, and Fb, and a dot pattern on the pixels “p”, in the case where a color sensor is used as the CMOS image sensor 240, and the wavelength of laser light is set as described above.

In the above configuration, for instance, as shown in FIG. 8C, in the case where three dots are irradiated onto the color filters shown in FIG. 6E, it is possible to detect all the dots to be irradiated onto the color filters Fr, Fg, and Fb. Specifically, as shown in FIG. 7, laser light of 830 nm is transmitted through the color filters Fr, Fg, and Fb substantially equally. Accordingly, all the dots irradiated as shown in FIG. 8C can be received on the pixels “p”, as shown in FIG. 8D.

As described above, according to the embodiment, it is possible to use an inexpensive and general-purpose color sensor as the CMOS image sensor 240. Accordingly, as compared with a configuration in which an expensive monochromatic sensor is used as the CMOS image sensor 240, the embodiment is advantageous in reducing the cost of the entirety of the device.

Further, according to the embodiment, the wavelength of laser light to be emitted from the laser light source 110 is set to about 830 nm. Accordingly, it is possible to properly detect laser light having a dot pattern by the CMOS image sensor 240. Further, setting the wavelength of laser light as described above makes it possible to obtain substantially the same sensitivities as with the case in which a color sensor is not provided with the color filters Fr, Fg, and Fb, as shown by the configuration “without color filters” in FIG. 7. Thus, it is possible to retain a high S/N ratio of a detection signal from the CMOS image sensor 240.

In the embodiment, the wavelength of laser light to be emitted from the laser light source 110 is set to about 830 nm. Alternatively, the wavelength of laser light may be set to any value, as far as the wavelength is in the infrared wavelength band, and it is possible to set the sensitivity of a pixel “p” corresponding to each of the color filters to a value near a local maximum value of the sensitivity.

For instance, in the case where the spectral characteristics of a color sensor to be used as the CMOS image sensor 240 are as shown in FIG. 7 and in FIGS. 9A to 9C, the detection sensitivity of a pixel “p” which detects light of each of the colors is kept to be high in the wavelength band from 810 to 870 nm. Accordingly, it is desirable to set the emission wavelength of the laser light source 110 in the wavelength band from about 810 to about 870 nm.

Further preferably, it is desirable to set the emission wavelength of the laser light source 110 to a wavelength near 830 nm (830±10 nm). The above configuration makes it possible to set the sensitivities of pixels “p” which detect G light and B light to substantially local maximum values in the infrared wavelength band, and makes it possible to set the sensitivity of a pixel “p” which detects R light to a value substantially equal to the local maximum values. Making the detection sensitivities of the pixels “p” which detect light of the respective colors substantially equal to each other as described above eliminates the need of adjusting the gain of an output signal from the color sensor with respect to each of the colors. Further, setting the emission wavelength of the laser light source 110 in a wavelength band where the sensitivities have substantially local maximum values eliminates a likelihood that the sensitivities sharply decrease even if the emission wavelength of laser light varies due to a temperature change. Accordingly, it is possible to perform a stable detecting operation.

As shown in FIG. 9B, in the case where the wavelengths at which the detection sensitivities of the pixels “p” which detect G light and B light have local maximum values are displaced from each other, the wavelength of the laser light source 110 may be set to a value near the wavelength at which one of the local maximum values is given. Also, in the above configuration, the wavelengths at which the respective local maximum values are given are displaced from each other only by about 10 nm. Accordingly, this also makes it possible to retain a high detection sensitivity with respect to light of the color, which gives the other of the local maximum values.

The embodiment of the invention has been described as above. The invention is not limited to the foregoing embodiment, and the embodiment of the invention may be changed or modified in various ways other than the above.

For instance, in the embodiment, the CMOS image sensor 240 constituted of a color sensor is used as a sensor which receives light having a dot pattern. It is possible to use a CCD image sensor constituted of a color sensor, in place of the CMOS image sensor constituted of a color sensor. Further, it is also possible to modify the configurations of the projection optical system 100 and the light receiving optical system 200, as necessary. Further, the information acquiring device 1 and the information processing device 2 may be integrated, or the information acquiring device 1 and the information processing device 2 may be integrated with a TV set, a game device, or a personal computer.

Further, in the embodiment, the filter 230 is disposed for removing light in a wavelength band other than the wavelength band of laser light to be irradiated onto a target area. In the case, however, where there is provided a circuit configuration of removing a signal component of light other than laser light to be irradiated onto a target area, from a signal to be outputted from the CMOS image sensor 240, it is possible to omit the filter 230.

Further, in the embodiment, a color sensor used as the CMOS image sensor 240 is provided with the color filters Fr, Fg, and Fb which respectively transmit R light, G light, and B light. Alternatively, the color sensor may be provided with color filters which respectively transmit cyan light, magenta light, and yellow light, in place of the color filters Fr, Fg, and Fb. In the case where a color sensor provided with the aforementioned color filters has the spectral characteristics as shown in FIG. 7 and in FIGS. 9A to 9C, setting the wavelength of laser light taking into consideration of the spectral characteristics also makes it possible to properly receive laser light having a dot pattern, as with the case of the embodiment.

Further, in the embodiment, laser light having a dot pattern is irradiated onto a target area from the projection optical system 100, and three-dimensional distance information of an object within the target area is acquired based on a displacement amount of a dot pattern included in each of the segment areas. Alternatively, the information acquiring device 1 may be configured in such a manner that three-dimensional distance information of an object within a target area can be acquired from the information acquiring device 1, with use of a time lag between an emission timing of the laser light source 110, and a light receiving timing of the laser light at each pixel “p”.

The embodiment of the invention may be changed or modified in various ways as necessary, as far as such changes and modifications do not depart from the scope of the claims of the invention hereinafter defined.

What is claimed is:

1. An information acquiring device, comprising:
a laser light source which emits laser light;
a projecting portion which projects the laser light emitted from the laser light source onto a target area; and
a light receiving portion which receives the laser light reflected on the target area, wherein
the light receiving portion includes a color image sensor into which the laser light reflected on the target area enters,
the color image sensor has characteristics such that a detection sensitivity of a pixel that detects light of a predetermined color gradually decreases, and detection sensitivities of pixels that detect light of colors other than the predetermined color respectively have local maximum values on a long wavelength side than a visible light region, the detection sensitivities of the respective pixels substantially coinciding with each other in a wavelength band near a wavelength at which the local maximum values are given, and
an emission wavelength of the laser light source is set to a wavelength in the wavelength band.

2. The information acquiring device according to claim 1, wherein
the emission wavelength of the laser light source is in a range of from 810 to 870 nm.

3. The information acquiring device according to claim 2, wherein
the emission wavelength of the laser light source is in a range of 830±10 nm.

4. The information acquiring device according to claim 3, wherein
the emission wavelength of the laser light source is set to 830 nm.

5. The information acquiring device according to claim 1, wherein
the emission wavelength of the laser light source is set to a wavelength near the wavelength at which the detection sensitivity of a pixel that detects light of one of the colors other than the predetermined color has the local maximum value.

6. The information acquiring device according to claim 1, wherein
the projecting portion includes a diffractive optical element which converts the laser light emitted from the laser light source into light having a dot pattern by a diffraction effect of the diffractive optical element, and
the light receiving portion is disposed to align with the projecting portion at a position away from the projecting portion by a predetermined distance.

7. The information acquiring device according to claim 1, wherein
the light receiving portion further includes a filter which guides only light in a wavelength band including the emission wavelength of the laser light source to the color image sensor.

8. The information acquiring device according to claim 1, wherein
the color image sensor includes pixels that detect red light, green light, and blue light.

9. An object detecting device, comprising
an information acquiring device,
the information acquiring device including:
a laser light source which emits laser light;
a projecting portion which projects the laser light emitted from the laser light source onto a target area; and
alight receiving portion which receives the laser light reflected on the target area, wherein
the light receiving portion includes a color image sensor into which the laser light reflected on the target area enters,
the color image sensor has characteristics such that a detection sensitivity of a pixel that detects light of a predetermined color gradually decreases, and detection sensitivities of pixels that detect light of colors other than the predetermined color respectively have local maximum values on a long wavelength side than a visible light region, the detection sensitivities of the respective pixels substantially coinciding with each other in a wavelength band near a wavelength at which the local maximum values are given, and
an emission wavelength of the laser light source is set to a wavelength in the wavelength band.

10. The object detecting device according to claim 9, wherein
the emission wavelength of the laser light source is in a range of from 810 to 870 nm.

11. The object detecting device according to claim 10, wherein
the emission wavelength of the laser light source is in a range of 830±10 nm.

12. The object detecting device according to claim 11, wherein
the emission wavelength of the laser light source is set to 830 nm.

13. The object detecting device according to claim 9, wherein
the emission wavelength of the laser light source is set to a wavelength near the wavelength at which the detection sensitivity of a pixel that detects light of one of the colors other than the predetermined color has the local maximum value.

14. The object detecting device according to claim 9, wherein
the projecting portion includes a diffractive optical element which converts the laser light emitted from the laser light source into light having a dot pattern by a diffraction effect of the diffractive optical element, and
the light receiving portion is disposed to align with the projecting portion at a position away from the projecting portion by a predetermined distance.

15. The object detecting device according to claim 9, wherein
the light receiving portion further includes a filter which guides only light in a wavelength band including the emission wavelength of the laser light source to the color image sensor.

16. The object detecting device according to claim 9, wherein
the color image sensor includes pixels that detect red light, green light, and blue light.
